(19) United States
(12) Patent Application Publication
(10) Pub. No.: US 2003/0169863 A1
(43) Pub. Date: Sep. 11, 2003

(54) Billing hierarchies

(76) Inventors: Milton Hernandez, River Edge, NJ (US); John M. Clark, Little Silver, NJ (US); Sanjeev Cherian, Iselin, NJ (US); Mike K. Lee, River Edge, NJ (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/352,739

(22) Filed: Jan. 28, 2003

Related U.S. Application Data
(60) Provisional application No. 60/352,353, filed on Jan. 28, 2002.

(51) Int. Cl. H04M 15/00

(52) U.S. Cl. 379/114.01

(57) ABSTRACT

The invention relates to a usage tracking and billing system that includes a hierarchy system made up of hierarchies containing entities representing the accountables, services, and service locations associated with usage data. In an example embodiment, the hierarchies are: (1) Organizational Hierarchy representing service users, service providers, and billed and billing parties, (2) Service Hierarchy representing services, and (3) Location Hierarchy representing the locations where services are used or provided. The hierarchies allow for correlation of service usage among the user(s), the service being used, and the location of where the services were consumed as well as provided. The end user may set the desired organizational structure, specify the locations (grouped by continent, etc. within a multinational organization), and provide an application view of what service usage is to be billed for and at what rate for the various groups and locations within the organization. The hierarchies are used to resolve service/system usage each day and the results are applied to the desired rate plan. In this fashion, the end user may build hierarchies that permit any number of rules to be applied to best mimic real world cost structures and conditions.

### CROSS REFERENCE TO RELATED APPLICATION

This application claims benefit of Provisional Application No. 60/352,353, filed Jan. 28, 2002, the entirety of which is incorporated herein by reference.

### TECHNICAL FIELD

The invention relates generally to the processing of data, and more particularly to tracking the usage of bandwidth and other fixed resources in a communication network and billing the users for their shares of usage.

### BACKGROUND OF THE INVENTION

Recently, the collection and processing of data transmitted over communication networks, like the Internet, has moved to the forefront of business objectives. In fact, with the advent of the Internet, new revenue generating business models have been created to account for the consumption of content received from a data network (i.e., content-based billing). For example, content distributors, application service providers (ASPs), Internet service providers (ISPs), and wireless Internet providers have realized new opportunities based on the value of the content and services that they deliver. As a result of this content-and-services-billing initiative, it has become increasingly important to resolve intelligently and flexibly the corresponding transactions according to the business needs of the customer.

Often, even in traditional commerce streams, there are many different participants between the maker and the consumer of the goods. Some of these so-called “middlemen” simply may facilitate access to the good, while others may add useful characteristics to the good. This is especially true in a distributed network environment, like the Internet, that impose additional burdens on capturing the transaction process because of the unlimited number of data sources and the correspondingly unlimited number of data types. As a result, adequately describing the transacting of the goods and services in such an environment, or even across any of the traditional environments, requires a technique that is capable of understanding and processing the participants and the various types of data.

To date, resolving the characteristics of a transaction has been accomplished over data-specific environments using certain application-specific (i.e., “non-generic” or custom) methods. For example, a typical telephone bill captures the characteristics of a voice-based telecommunications transaction. In particular, the participants may be identified as the party initiating the call (i.e., the “calling party” telephone number), the party receiving the call (i.e., the “called party” telephone number), and one or more parties connecting the communication (i.e., the “local” or “long distance carrier”). This simple example adequately captures all of the necessary aspects of the telephone call to properly account for the transaction by requiring payment from certain parties (e.g., the calling and/or the called party) to certain other parties (e.g., the local and/or long distance carrier). While these “hard-coded” transaction resolution techniques are sufficient to accommodate only specific environments involving well-defined participants (e.g., the telecommunications network), they are correspondingly too rigid to efficiently satisfy the ever-changing face of a communication network like the Internet. Also, these “hard-coded” techniques are too specific to operate across the many and varied transaction environments and domains that exist throughout the business world.

Existing techniques for tracking data content or bandwidth usage and the like do not allow for flexible billing techniques that allow the system to automatically determine who is using the resource, from where, and what service is being provided. Such information is particularly desirable to provide more accurate billing and better usage accountability within a large organization. It is desirable for existing billing systems to be modified to allow the end user to set the organizational structure for multiple locations and multiple categories of products and services so that a more meaningful rate plan may be established for intra- and extra-company use of services such as email, storage, and bandwidth. The present invention has been designed to address these needs in the art.

### SUMMARY OF THE INVENTION

The present invention includes a hierarchy system made up of 3 hierarchies containing entities representing the accountables, services, and service locations associated with usage data. In a preferred embodiment, the 3 hierarchies are:

1. Organizational Hierarchy representing service users, service providers, and billed and billing parties;

2. Service Hierarchy representing services; and

3. Location Hierarchy representing locations where the service is used or provided.

The 3 hierarchies allow for correlation of service usage among the user(s), the service being used, and the location of where the services were consumed as well as provided.

These hierarchies are used in accordance with the invention in a system and method of tracking and billing for usage of a network service. The resulting system implements a method, comprising the steps of:

establishing an organizational hierarchy representing network service users, network service providers, and/or billed and billing parties that use the network service;

establishing a service hierarchy for different aspects of the network service;

establishing a location hierarchy for different locations within the network; and

resolving usage of the network service according to service usage among the user(s), the service being used, and the location of where the services were consumed as specified by the organizational, service, and location hierarchies for the network service.

In accordance with the invention, the end user may set the desired organizational structure, specify the locations (grouped by continent, etc. within a multinational organization), and provide an application view of what service usage is to be billed for and at what rate for the various groups and locations within the organization. The hierarchies are used to resolve service/system usage each day and the results are applied to the desired rate plan. In this fashion, the end user may build hierarchies that permit any number of rules to be applied to best mimic real world cost structures and conditions. The invention also may track changes in the organizational, service and location hierarchies over time so as to allow the recreation of the organizational, service and location hierarchies at a particular point in time in the past.

The invention thus describes a method, system, and computer-readable medium having computer-executable instructions for determining who is using what service and where such usage is occurring. The invention may be applied for monitoring usage of fixed resources such as email, system data storage, and bandwidth to determine what to charge each organizational unit that uses such services. This approach allows for a billing specificity previously unavailable to small or large companies or institutions. All or some of the inventive method steps may be conducted on a computer-readable medium using computer-executable instructions.

### BRIEF DESCRIPTION OF THE DRAWINGS

Other features of the invention are further apparent from the following detailed description of the embodiments of the invention taken in conjunction with the accompanying drawings, of which:

FIG. 1 is a block diagram of a system for analyzing content transmitted over a communication network according to the invention;

FIG. 2 is a detailed block diagram further describing the components of the system described in FIG. 1;

FIGS. 3A and 3B provide a flow diagram further detailing the operation the system described in FIG. 1;

FIG. 4 illustrates a sample tree for the service hierarchy in accordance with the invention;

FIG. 5 illustrates a sample tree for the organizational hierarchy in accordance with the invention; and

FIG. 6 illustrates a sample tree for the location hierarchy in accordance with the invention.

### DETAILED DESCRIPTION OF THE INVENTION

System Overview

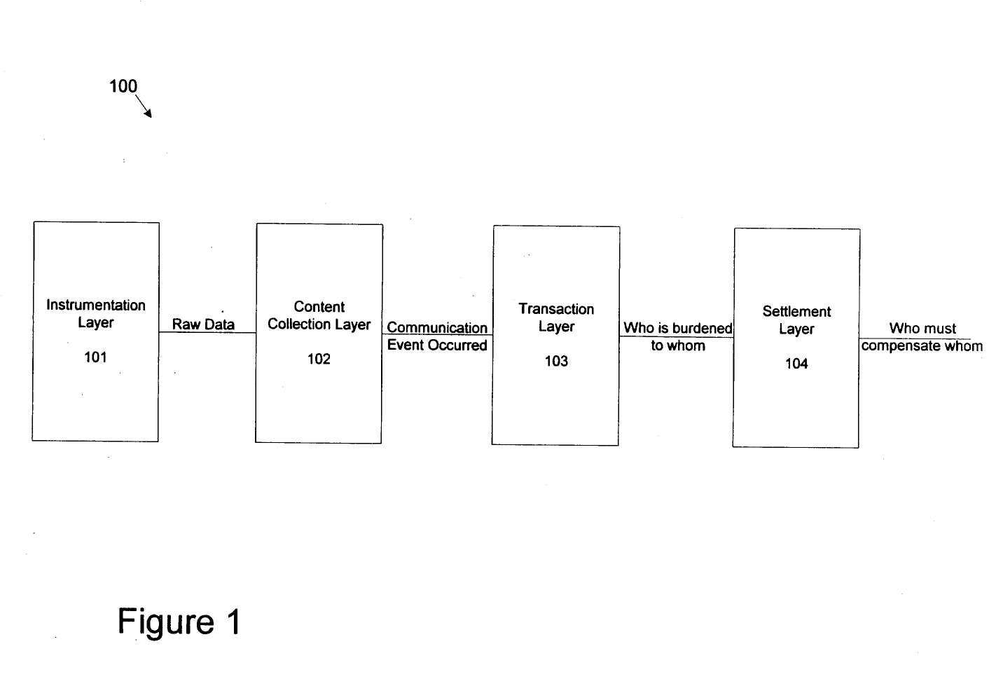

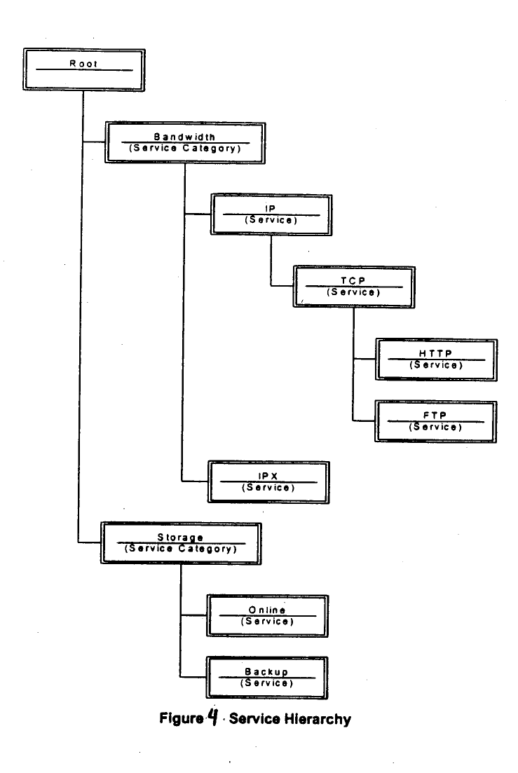

A sample system for implementing the techniques of the invention will be described in this section with respect to FIGS. 1-3. Details of the hierarchies system of the invention will be described in the next section with respect to FIGS. 4-6.

FIG. 1 is a block diagram of a system 100 for analyzing content transmitted over a communication network. Although the following description will be discussed in the context of collecting, processing and billing for data transmitted over the Internet, it should be appreciated that the invention is not so limited. In fact, the invention may be applied to any type of network, including a private local area network, for example. Also, the invention may be used for purposes other than billing for the usage of content. For example, the invention may be used to analyze the type of data transmitted over a particular network, to determine the routing patterns of data on a network, and to determine storage and bandwidth usage. In addition, the invention may be used to track specific Internet protocol (IP) network resources and to detect fraud, for example. It should also be appreciated that the invention may contemplate non-network and non-computer related business domains like commodity trading (e.g., grains, crude oil) where multiple parties are involved. Therefore, although the invention is often described in the context of the Internet, it should be appreciated that the invention may equally applied to traditional business environments.

In addition, it should be appreciated that the term “content” may be defined as data that is transmitted over the network. In the context of the Internet, content may include .mp3 files, hypertext markup language (html) pages, videoconferencing data, email, and streaming audio, for example. The terms “content provider” and “customer” will be used throughout the description as well. Content provider may refer to the primary creator or provider of the content, while customer is the primary recipient of the content. Both the producer and customer may be a human or a computer-based system.

As shown in FIG. 1, an instrumentation layer 101 provides raw data to a content collection layer 102. Instrumentation layer 101 may consist of various data sources, for example, network routers. The network routers may provide information regarding the various types of routed data, including for example, data format, originating Internet protocol (IP) address, and destination IP address. One example of such information is Cisco System's NetFlow™.

Content collection layer 102 collects information about the delivery of the content, as well as the substance of the content itself. Content collection layer 102 also may sort, filter, aggregate, correlate and store the content according to the particular needs of the end user. In effect, content collection layer 102 is responsible for extracting meaningful information about IP traffic, and so it is provided with an understanding of the data sources in instrumentation layer 101. Content collection layer 102 also may transform the data from the plurality of sources in instrumentation layer 101 into standard formats for use in a transaction layer 103.

Content collection layer 102 is in communication with transaction layer 103. Generally, content collection layer 102 reports to transaction layer 103 that a relevant communication event has occurred and should be considered by the remainder of system 100. A communication event may be defined as any transfer of data between systems. Transaction layer 103 captures the predetermined agreements among all of the parties involved in system 100 regarding the value of the transferred content, as well as the value added by each of the individual parties in transferring such content. Therefore, transaction layer 103 is charged with understanding the nature of the parties, as well as the understanding the actions that one or more parties perform and the influence of such action on the respective parties.

Transaction layer 103 is in communication with a settlement layer 104. Settlement layer 104 captures the operations that are necessary to understand the significance of the transaction defined by transaction layer 103. For example, settlement layer 104 may rate a particular transaction by assigning a monetary value to the transaction. Settlement layer 104 also may divide the burdens and benefits of the monetary value among the relevant parties. In this way, settlement layer 104 ensures that certain parties receive a particular portion of the payment made by the other parties. Settlement layer 104 also may be responsible for delivering this burden and benefit information to the appropriate parties with the appropriate identifiers (e.g., account numbers).

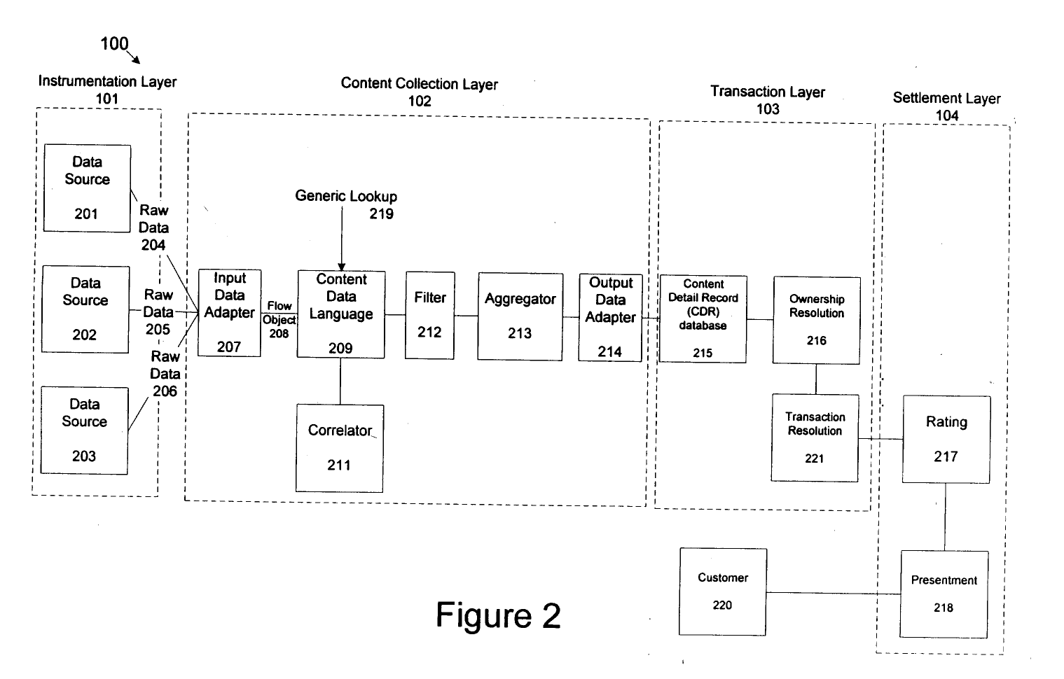

FIG. 2 is a block diagram further describing the components of system 100. As shown in FIG. 2, instrumentation layer 101 includes data sources 201-203 that provide raw data 204-206, respectively, to collection layer 102. As discussed, data sources 201-203 may include various internetworking devices like routers, bridges, and network switches. Data sources 201-203 provide raw data to an input data adapter 207. Accordingly, input data adapter 207 understands the operation of and the data provided by data sources 201-203. Although one input data adapter is shown in FIG. 2, it should be appreciated that more than one input data adapter may be used in system 100. For example, each data source may have a dedicated input data adapter. Also, many such data sources and input data adapters may be provided as necessary to manage the data flow for a particular system.

Input data adapter 207 understands the incoming data and extracts the data into the appropriate fields. This field-delimited data, called flow objects 208, are sets of attributes. The attributes may be any characteristics that are provided by, or can be derived from, raw data 204-206 provided by data sources 201-203, respectively. For example, flow objects 208 may include a set of attributes describing the source and destination, including source IP address, destination IP address, source interface, and destination interface. Because input data adapter 207 is charged with understanding raw data 204-206 from data sources 201-203, as well as the required flow objects 208 of system 100, it is capable of transforming the raw data to the flow objects, where the flow objects may all be of a standard format.

Input data adapter 207 provides flow objects 208 to a content data language block 209. Content data language block 209 may transform the attributes in flow objects 208 into other attributes that are desired by a particular customer. For example, content data language block 209 may derive a network identifier attribute that is not readily available from a data source, from a source address attribute and a destination address attribute that are provided by flow object 208 attributes from input data adapter 207. This derivation may be based on a customer's desire to determine which network conveyed the transaction between the source and the destination. Therefore, following this example, content data language block 209 will know to extract the source address attribute and the destination address attribute from flow objects 208.

Content data language block 209 may perform other functions as well. For example, content data language block 209 may perform a generic lookup function 219 that is built into content data language 209. Generally, generic lookup 219 describes a technique for mapping any number of attributes to any number of other derived attributes. For example, generic lookup 219 may be used to map a unique resource locator (URL) attribute to a particular content-type attribute.

Content data language block 209 also is in communication with a correlator 211. Generally, correlator 211 connects the many daily network content events from various network devices, like routers for example. Often, the connected data may come from distinctly different data sources at distinctly unrelated times. Correlator 211 allows this data to be intelligently connected to each other, regardless of how different the sources or of how disparate the time received. For example, a Netflow™ enabled router and a Radius™ enabled network access switch may each provide certain data that is relevant to one particular transaction. However, because portions of the data come from different devices, the data may arrive at system 100 at different times, and in different formats. Also, because each provides data that is necessary to complete one transaction, the data from each cannot be considered separately. Correlator 211 allows this data to be intelligently grouped regardless of the format of the data or of the time the data pieces are received.

Furthermore, correlator 211 may rearrange the order of the received flow objects 208 to suit the needs of the remainder of system 100. By performing such correlation without having to first store all of the data on a disk (e.g., a database), significantly faster processing is achieved. Correlator 211 may perform this correlation in real-time, for example.

Although system 100 has been described using content data language block 209 and correlator 211, it should be appreciated that flow objects 208 may proceed directly to a filter 212, if no correlation is required and if no attribute derivation is required, for example. Filter 212 analyzes flow objects 208 to ensure that the provided attributes are desired by system 100. If flow objects 208 are not needed (i.e., a mismatch), filter 212 may prevent flow objects 208 from passing to an aggregator 213. Also, although filter 212 has been shown as a separate device in system 100, it should be appreciated that the functionality of filter 212 may be incorporated into aggregator 213.

Filter 212 passes the matching flow objects to aggregator 213. Aggregator 213 may provide additional filtering and classification of the multitude of daily network content transactions, based on user criteria. Aggregator 213 may perform such filtering and classification in real-time. Aggregator 213 provides the filtered and classified information to an output data adapter 214. Output data adapter 214 may convert the data from aggregator 213 into one or more content detail records for storage in CDR database 215. Therefore, CDR database 215 stores a complete description of a content event.

Transaction layer 103 includes CDR database 215, an ownership resolution component 216, and a transaction resolution component 221. CDR database 215 passes the CDR onto ownership resolution component 216. A proper accounting of a communication event, for any purpose including billing, requires both identifying the participants and defining the relationships among those participants. These tasks are accomplished by ownership resolution component 216 and transaction resolution component 221.

Ownership resolution component 216 serves to define the direct and indirect participants of the communication event. In particular, because raw data 204-206 may not provide sufficient “ownership” data relating to the parties involved in the content transaction, such “ownership” data must be provided by system 100 to properly account for the entire transaction. Ownership resolution component 216 operates to provide such ownership-based data to system 100.

Ownership resolution component 216 is in communication with transaction resolution component 221. Transaction resolution component 221 serves to capture the predetermined relationships and/or agreements among the parties defined by ownership resolution component 216 regarding the value of the transferred content, as well as the value added by each of the individual parties in transferring such content. Such predetermined relationships may be previously agreed upon by the participants, or may be created and agreed upon with the implementation of system 100. Therefore, transaction component 103 understands the nature of the parties, the actions that one or more parties perform, and the influence of such action on the respective parties. Ownership resolution component 216 and transaction resolution component 221 will be discussed in greater detail.

Transaction resolution component 221 provides the transaction information to a rating component 217. Rating component 217 provides a weight or significance (e.g., a price) to the transaction, so as to provide a tangible value to the transaction. Rating component 217 may make this determination based on various metrics including the type of the content, the quantity of content consumed, the place and time delivered, or the quality of the content for example. Therefore, rating component 217 allows system 100 to provide some contextual value, indicting the significance or relevance that certain content or information has to the individual customer.

Rating component 217 provides the rated transaction to a presentment component 218. Presentment component 218 may provide the capability for a customer 220 to view their real-time billing information, for example, over the network. Presentment component 218 also may attach relevant identifiers to the bill (e.g., account numbers, etc.).

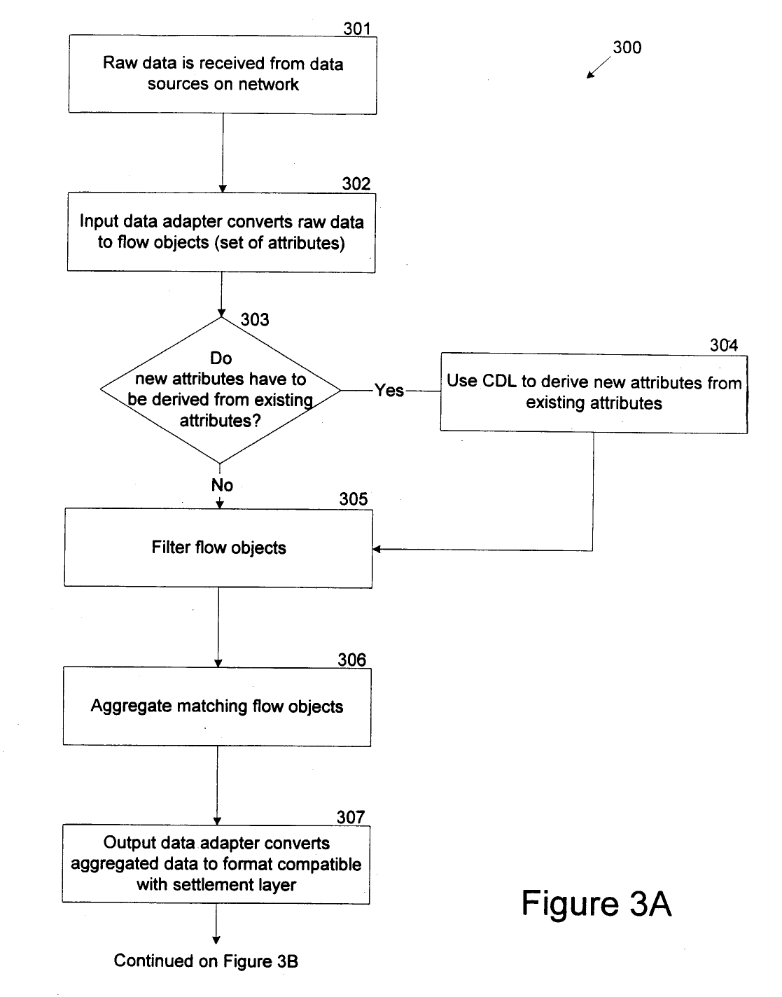

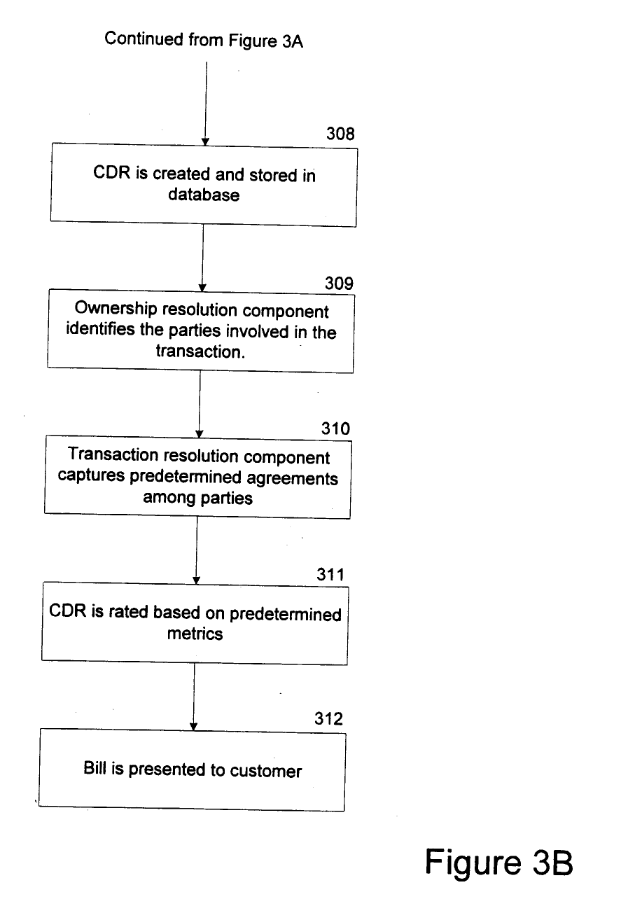

FIGS. 3A and 3B provide a flow diagram further detailing the operation 300 of system 100. As shown in FIG. 3A, in step 301, raw data 204-206 is received from data sources 201-203. In step 302, input data adapter 207 converts raw data 204-206 to flow objects 208, where flow objects 208 are sets of attributes, determined from raw data 204-206. In step 303, it is determined whether there is(a need to derive new attributes from the existing attributes found in flow objects 208. If there is such a need, in step 304, CDL 209 is used to derive new attributes from existing attributes. Also, as discussed above, attributes may be correlated by correlator 211.

In step 305, flow objects 208 are filtered by filter 212. In step 306, the matching flow objects (i.e., those passed by filter 212) are further filtered and classified by aggregator 213. In step 307, output data adapter 214 converts the data aggregated by aggregator 213 to a format compatible with transaction layer 103 and settlement layer 104.

As shown in FIG. 3B, in step 308, output data adapter 214 may format the aggregated data into one or more content data records for storage in CDR database 215. In step 309, ownership resolution component 216 identifies the parties involved in the transaction, including parties within a specified organizational structure. In step 310, transaction resolution component 221 captures the predetermined agreements among the parties, the value added by each of the individual parties, and the service and location hierarchies specified by the user (see below). In step 311, the CDR is rated based on predetermined metrics (e.g., time of transmission, quality of content). In step 312, a bill is presented to the customer.

Further details regarding the content/transaction resolution system described above can be found in commonly owned U.S. patent application Ser. No. 09/934,123, filed Aug. 21, 2001, the contents of which are hereby incorporated by reference in their entirety.

Hierarchies

As will be explained in more detail below, the hierarchies technique of the invention is used in, or in connection with, the ownership resolution component 216 and the transaction resolution component 221 of transaction layer 103 to permit the system to account for which user is using the content (ownership), what is being used and from where (transaction) so that the appropriate service level from the rating plan may be applied (settlement). In other words, the hierarchies of the invention are implemented in the transaction layer 103 and a modified rating plan is implemented in settlement layer 104 to implement the hierarchy techniques of the invention.

In accordance with the invention, hierarchies consist of two main parts, structure and content. All three hierarchies (organizational, service, location) contain entities organized in a tree structure where each entity can have a single parent and multiple children. Each entity has associated content that is specific to the purpose of the hierarchy. Entities in the organizational hierarchy will contain accountable information. Entities in the service hierarchy will contain service information, and so on.

Other than the single parent rule, the structure of the hierarchies is definable by the user without having to specify a template beforehand. In other words, there is no restriction on the depth or breadth of a hierarchy. It is the responsibility of the user to create a meaningful, accurate representation of their organization, services and locations for application of the hierarchies of the invention.

Users can add custom fields to any entity in a hierarchy for capturing additional content. These custom fields contain contact information, geographic information, notes, etc.

The hierarchies are time-sensitive, or temporal. As a hierarchy changes over time, the changes are tracked so that a hierarchy can be reproduced at any point in the past. Possible uses for this capability would be to reproduce the state of the hierarchies at the time a usage event occurred for resolution and plan selection.

Service Hierarchy

The service hierarchy contains entities representing the services used or provided by an enterprise, such as email, storage, and bandwidth. FIG. 4 illustrates a sample tree for the service hierarchy in accordance with the invention.

Entities in the service hierarchy of FIG. 4 consist of Service Categories (e.g., bandwidth and storage) and Services (e.g., IP, TCP, HTTP, FTP, etc.). As shown, a Service Category contains one or more Services. A Service may contain other like-Services. The IP and TCP Services in FIG. 4 are an example of a Service-to-Service relationship. The relationship between IP and TCP is that TCP is a further refinement, or qualification, of network usage.

As an example, if one were to assume that there is a usage type called RMONUsage with 2 identifiers, layer3proto and layer4proto, the RMONUsage type would be specified as the usage type for the Bandwidth category and, subsequently, is the usage type for the IP Service in that category. The qualifier to identify an RMONUsage type usage record as belonging to (or representing) the IP service would be:

layer3proto=‘ip’

The TCP service, as sub service of IP, would also be based on the RMONUsage type and would have a qualifier:

layer3proto=‘ip’ AND layer4proto=‘tcp’

These qualifiers will be used by the transaction layer 103 to resolve the service for a given usage record.

A Service Category is represented by a single usage type representative of the kind of Service, where all Services defined within the category are constrained to operate on this usage type. The expectation here is that the system will support usage types that normalize usage from multiple, similar data sources representing a service. On the other hand, a set of 1 or more plan templates may be used. Plan templates are plan definitions requiring parameterization to be used. All plan templates in the category know how to rate usage of the type specified. Because all services in a category are constrained to use the usage type defined in the category, all plan templates defined by the category are available for use in the contained services. A plan template will become a plan instance when an entity in the organizational hierarchy, designated as a service provider, specifies parameters for the plan such as tariffs.

A Service is represented by:

1. A usage type inherited from the Service Category.

2. A service filter that is an expression comparing one or more literals to usage type identifier values for the purpose of resolving a usage record to the service.

3. A set of 1 or more owner identifiers that are attributes in the usage type whose values in a usage record will dictate who owns the usage. When an organizational entity is designated as a service user, values for each identifier must be specified for owner resolution.

4. A set of zero or more reliant services to support multi-stage billing.

A mapping of usage type to the service filter expressions will be maintained so that transaction layer 103 can iterate over the expressions by usage type to determine what service a usage record belongs to.

Organizational Hierarchy

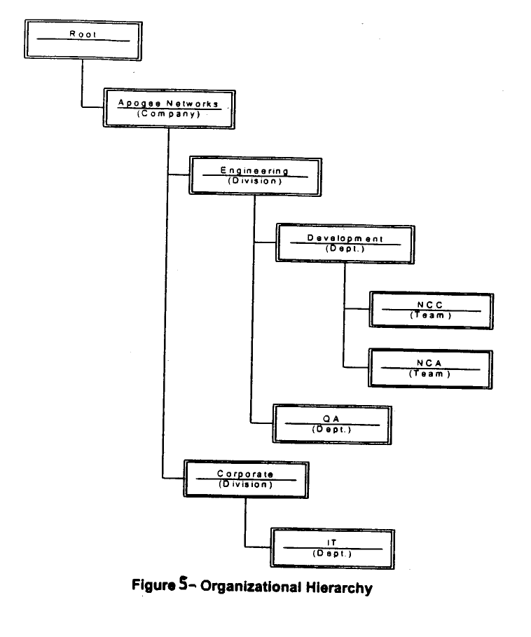

The Organizational hierarchy contains entities representing the accountables of usage data. As shown by way of example in FIG. 5, the user will create entities according to the organizational structure of their enterprise. Entities in the organizational hierarchy can be service consumers, service providers, or both. When creating entities in the organizational hierarchy, the user can indicate the entity uses and/or provide one or more services. Service users and providers need not be individuals. As shown in FIG. 5, the service users can be Teams, Departments, Divisions etc.

The user may also provide other information such as rate level and ownership responsibility for 0 or more organizational entities. An entity can indicate responsibility for the percentage cost or usage of another entity.

As noted previously, an entity can use more than one service. The usage of a service is implied through the ownership identifier values (a.k.a. assets) configured for the user. For example, a user could be configured with a hostname, myhost, which could match the originating address in a usage event for the HTTP service as well as a usage event for the Storage service. Assets can also be shared by multiple users, allowing for a fair allocation of responsibility among multiple users. Optionally a user can select a rate plan for a service based upon the plans offered by the service provider, defined as an organizational entity that provides one or more services. For each service, a service provider is represented by:

1. The Service being provided.

2. One or more rate plan instances for the service. As the provider of a service, it is the provider who owns the rate plans associated with the service. A provider can offer one or more of the plan templates specified in the Service Category to service users. Once selected by the user, a plan template is parameterized with tariffs (by the provider) and then saved as plan instances. It's the plan instances that are used by the rating engine to rate service usage.

3. A default rate plan for the service. One plan must be specified as the default so that in case a service user does not explicitly choose a plan, this default will be selected during the rating step.

Optionally a provider definition could include the costs of providing the service (e.g. link costs). Also, The cost of providing the service can be used to support cost recovery plans.

Multiple providers may be permitted, but the service user must pick a provider. Also, a provider may be designated as the default provider. Thus, while an organizational entity can be designated as a provider of one or more services, there can only be 1 provider of a service. This restriction is necessary to avoid ambiguity either when explicitly choosing a plan for a service user or when selecting a plan during rating.

For each usage record, the rating system needs to know which plan instance to use for rating the usage. The rating system will receive usage records that have been resolved by the transaction layer 103 that contain service type, consumer, provider, and the like. When the rating system requests the plan instance for a given usage record, the following simple selection algorithm will be used:

If the Consumer has explicitly identified a plan for the Service,

Return the plan

Else

Return the Providers default plan for the Service.

Location Hierarchy

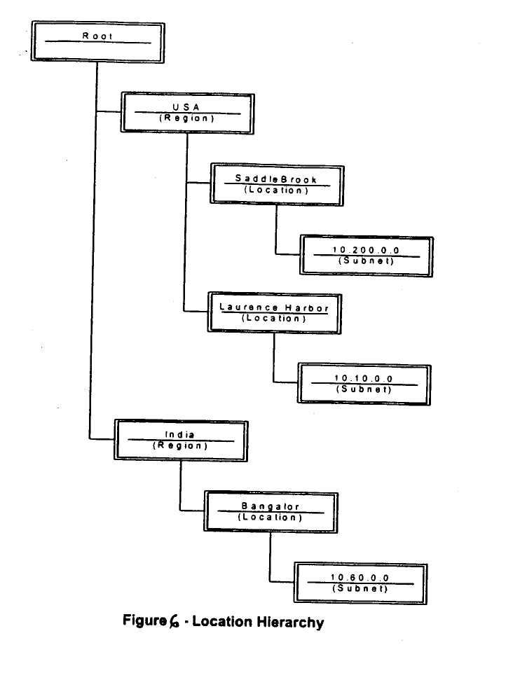

As shown in FIG. 6, the Location Hierarchy will contain entities to represent the locations of service enabling resources and service users within the enterprise. Regions, locations, and the like are examples of what can exist, not what must exist. The Location hierarchy is nearly identical in form and function with the system described in the previous section. The exception is for ownership identifier values (a.k.a. locators for the location hierarchy) that cannot be shared among multiple locations.

Design Considerations

In a preferred embodiment of the invention, as a hierarchy changes over time the changes will be tracked so that a hierarchy can be reproduced at any point in the past. The hierarchies are preferably represented by a tree structure in which each element can have one and only one (OOO) parent and multiple children. Structures will vary across hierarchies, some more strictly enforced than others. A hierarchy entity can have one or more custom fields specified by the user. The transaction layer 103 will need to access the hierarchy data for consumer, provider, service, and period resolution. The rating system will need to access hierarchy data for plan selection. The reporting system will need to access hierarchy data for report definitions and ad-hoc bill viewing.

For a given transaction, one and only one plan will be chosen for rating the transaction. The Provider of a Service will always have at least one plan and one plan identified as the default for the Service. The definition of Service Categories and Services depend upon usage types.

While the invention has been particularly shown and described with reference to the embodiments thereof, it will be understood by those skilled in the art that the invention is not limited to the embodiments specifically disclosed herein. Those skilled in the art will appreciate that various changes and adaptations of the invention may be made in the form and details of these embodiments without departing from the true spirit and scope of the invention as defined by the following claims.

What is claimed is:

1. A method of tracking and billing for usage of a network service, comprising:
establishing an organizational hierarchy representing at least one of network service users, network service providers, billed and billing parties that use said network service;
establishing a service hierarchy for different aspects of said network service;
establishing a location hierarchy for different locations within the network; and
resolving usage of the network service according to service usage among the user(s), the service being used, and the location of where the services were consumed as specified by said organizational, service, and location hierarchies for the network service.

2. The method of claim 1, wherein the user may set the desired organizational structure for the organizational hierarchy, specify the locations for the location hierarchy, and provide an application view of what service usage is to be billed for and at what rate for the various groups and locations within the organizational hierarchy.

3. The method of claim 1, comprising the additional steps of resolving service/system usage on a periodic basis using the organizational, service and location hierarchies and applying the results to a desired rate plan for the service usage.

4. The method of claim 1, comprising the additional step of tracking changes in the organizational, service and location hierarchies over time so as to allow the recreation of the organizational, service and location hierarchies at a particular point in time in the past.

5. The method of claim 1, wherein the network service comprises at least one of email usage, data storage, and bandwidth usage.

6. A system that tracks and bills for usage of a network service, comprising:
a network service ownership resolution component comprising representations of an organizational hierarchy representing at least one of network service users, network service providers, billed and billing parties that use said network service, a service hierarchy for different aspects of said network service, and a location hierarchy for different locations within the network; and
a network service transaction resolution component that resolves usage of the network service according to service usage among the user(s), the service being used, and the location of where the services were consumed as specified by said organizational, service, and location hierarchies for the network service.

7. The system of claim 6, wherein the network service ownership resolution component also includes a representation of different network service rate plans for the various groups and locations within the organizational hierarchy.

8. The system of claim 7, wherein the network service transaction resolution component resolves service/system usage on a periodic basis using the organizational, service and location hierarchies and applies the results to a desired network service rate plan for the service usage.

9. The system of claim 6, wherein the network service ownership resolution component tracks changes in the organizational, service and location hierarchies over time so as to allow the recreation of the organizational, service and location hierarchies at a particular point in time in the past.

10. The system of claim 6, wherein the network service comprises at least one of email usage, data storage, and bandwidth usage.

11. A computer readable medium containing data that when read by a computer enables the computer to track and bill for usage of a network service in accordance with a method comprising the steps of:
establishing an organizational hierarchy representing at least one of network service users, network service providers, billed and billing parties that use said network service;
establishing a service hierarchy for different aspects of said network service;
establishing a location hierarchy for different locations within the network; and
resolving usage of the network service-according to service usage among the user(s), the service being used, and the location of where the services were consumed as specified by said organizational, service, and location hierarchies for the network service.

12. The medium of claim 11, wherein the data enable the computer to allow a user of the computer to set the desired organizational structure for the organizational hierarchy, specify the locations for the location hierarchy, and provide an application view of what service usage is to be billed for and at what rate for the various groups and locations within the organizational hierarchy.

13. The medium of claim 11, wherein the data enable the computer to perform the additional steps of resolving service/system usage on a periodic basis using the organizational, service and location hierarchies and applying the results to a desired rate plan for the service usage.

14. The medium of claim 11, wherein the data enable the computer to perform the additional step of tracking changes in the organizational, service and location hierarchies over time so as to allow the recreation of the organizational, service and location hierarchies at a particular point in time in the past.

15. The medium of claim 11, wherein the network service comprises at least one of email usage, data storage, and bandwidth usage.
